(19) United States
(12) Patent Application Publication
(10) Pub. No.: US 2017/0284048 A1
(43) Pub. Date: Oct. 5, 2017

(54) MEANS OF MOUNTING AND INSTALLING A FABRIC TO PROVIDE A FENCE FOR SEPARATING OIL FROM BODIES OF WATER

(71) Applicant: Cerex Advanced Fabrics, Inc., Cantonment, FL (US)

(72) Inventors: Albert E. ORTEGA, Pensacola, FL (US); Daniel Patrick BAILLIE, Pensacola, FL (US); Erin S. CARTER, Pensacola, FL (US); James D. BOSTWICK, Milton, FL (US)

(21) Appl. No.: 15/477,461

(22) Filed: Apr. 3, 2017

Related U.S. Application Data
(60) Provisional application No. 62/316,657, filed on Apr. 1, 2016.

(51) Int. Cl. E02B 15/08

(52) U.S. Cl. CPC E02B 15/08; E02B 15/0814; E02B 15/0807; B01D 17/02

(57) ABSTRACT

Means for easily mounting fabric on stakes or posts and installing a fence that separates oil from water on land, on shorelines, or bodies of water are provided, as are methods of fabricating and methods of deploying such a mounting fabric. A fabric can be securely and easily mounted to stakes or posts to fabricate a fence that separates oil from water. The fabric can be a strong, lightweight fabric for separating spilled oil from water.

### CROSS-REFERENCE RELATED APPLICATION

This application claims the benefit of U.S. Provisional Application Ser. No. 62/316,657, filed Apr. 1, 2016, the disclosure of which is hereby incorporated by reference in its entirety, including any figures, tables, and drawings.

### BACKGROUND

Spills are an unfortunate accident in industry and transport of chemicals. When a spill occurs, the company or companies responsible for the spill mobilize cleanup efforts. Several methods are used to remove oil from the water. Fences made of fabric can sometimes be used to attempt to assist such cleanup efforts.

Fence fabric is currently installed on land, shorelines, or in bodies of water by punching sharpened baling wire or cable ties, or both, through the fabric and tying the wire to a post that has been inserted into the ground. A “T” post is commonly used. The length of the baling wire is around six inches long. The baling wire or cable ties are usually fastened at three points of the fence fabric—at the top, the middle, and then about one to about three inches from the bottom of the fabric. A strand of baling wire or a cable tie are typically run across the top of posts or stakes and then the top of the fence fabric is tied to the baling wire using straps of fabric or more baling wire. The ends are twisted, usually with wire cutters or a similar tool, to the post after inserting the wire through the fabric. Tension is placed on the fabric as it is deployed so as to limit sagging once installed.

### BRIEF SUMMARY OF THE INVENTION

Embodiments of the subject invention relate to means of mounting and installing a fabric to provide a fence made from a fabric that separates oil from water, as well as several methods that can be used to deploy and install the fence on land or in bodies of water.

Embodiments of the subject invention provide means for easily mounting fabric on stakes or posts (or other support element, including but not limited to trees) and installing a fence that separates oil from water either on land, shorelines, or bodies of water. An object of this invention is to provide means to securely and easily mount a fabric to stakes or posts to fabricate a fence that separates oil from water. A further object of this invention is to provide means wherein the fence can be installed easily on land, shorelines, or in water. It is yet another object of this invention to provide means that requires minimal or no use of tools in the field for installation of the fence.

When an oil spill has occurred, oil can be removed from water by fabricating a fence from a fabric that separates oil from water. Once the fence is installed, oil can be removed from bodies of water using various techniques including but not limited to skimmers and absorbent pads. Embodiments of the subject invention provide means for installing a fabric in bodies of water as a fence that can be used to contain or separate spilled oil and other materials from bodies of water such as swamps, rivers, streams, lakes, bays, ponds, wetlands, swamps, gulfs, and oceans. Embodiments also provide means for installing a fabric as a fence on land or shorelines to prevent or inhibit oil from contaminating bodies of water.

### BRIEF DESCRITPION OF THE DRAWINGS

FIG. 1 shows an image of installing a fence in a stream, according to the related art.

FIG. 2 shows an image of a fence fabric according to an embodiment of the subject invention.

FIG. 3 shows an image of a fence fabric according to an embodiment of the subject invention installed on land.

FIG. 4 shows an image of a fence fabric according to an embodiment of the subject invention installed on land.

FIG. 5 shows an image of a fence fabric according to an embodiment of the subject invention.

### DETAILED DISCLOSURE OF THE INVENTION

In the following detailed description of the subject invention and its preferred embodiments, specific terms are used in describing the invention; however, these are used in a descriptive sense only and not for the purpose of limitation. It will be apparent to the skilled artisan having the benefit of the instant disclosure that the invention is susceptible to numerous variations and modifications within its spirit and scope. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

Strong fabrics that absorb oil or that separate oil from water can be used to fabricate an oil containment or separation fence to contain spilled oil in bodies of water such as swamps, lakes, streams, bays, gulfs, and oceans. These fabrics can also be used to fabricate an oil containment or separation fence that can be installed on land or shorelines to prevent oil from contaminating bodies of water. US. Pat. No. 8,882,399 B2 describes fabrics that can be used in this invention and is incorporated herein by reference in its entirety. In one embodiment, a strong nonwoven fabric made of a single layer can be used as fence fabric to contain spilled oil from the environment. In a preferred embodiment, the fabric has a basis weight of about 3 ounce per square yard (osy) as measured using American Society for Testing and Materials test method (ASTM) D3776, thickness of about 19 mils as measured using ASTM D1777, machine direction grab tensile strength of at least about 115 lbs_{f} as measured using ASTM D5034, machine direction grab elongation of about 84% as measured using ASTM D5034, cross direction grab tensile strength of at least about 86 lbs_{f} as measured using ASTM D5034, cross direction grab elongation of about 94% as measured using ASTM D5034, machine direction trapezoidal tear strength of at least about 35 lbs_{f} as measured by ASTM D5587, cross direction trapezoidal tear strength of at least about 24 lbs_{f} as measured by ASTM D5587, air permeability of about 190 ft³/min/ft² as measured by ASTM D737, a burst strength of at least about 79.3 pounds per square inch (PSI) as measured by ASTM D3786, a mean pore size of about 34.1 microns, retention of at least about 87% of its machine direction grab strength as measured using ASTM D5034 when exposed to a xenon light source for 1000 hours, continuous nylon filaments, and wicks oil and water.

Mean pore size can be measured by any suitable method known in the art. For example, the mean pore size can be measured using an instrument as discussed in a publication by Jena et al. (Jena, A. and Gupta, K., Advances in Pore Structure Evaluation by Porometry, Porous Materials Inc., http://www.pmiapp.com/publications/docs/Review-Papers/Advances-in-P-ore-Structure-Evaluation-by-Porometry.pdf), which is hereby incorporated by reference in its entirety. This fabric will pass the criteria for SW-846, Third Edition which is the EPA standard for allowing wastes to be treated as non-hazardous waste. The EPA publication SW-846, entitled Test Methods for Evaluating Solid Waste, Physical/Chemical Methods, is Waste's official compendium of analytical and sampling methods that have been evaluated and approved for use in complying with the RCRA (Resource Conservation and Recovery Act) regulations. SW-846 functions primarily as a guidance document setting forth acceptable, although not required, methods for the regulated and regulatory communities to use in responding to RCRA-related sampling and analysis requirements.

Other polymers or combinations of polymers including but not limited to polyester and polypropylene can be used to make a similar fabric. The fabric can be made from filaments that comprise more than one polymer such as bicomponent or tricomponent filaments. The fabric is thermally bonded with the pattern illustrated in registered U.S. Pat. No. 2,163,116. This fabric is sold under the trademarks PBN-II® and OIL SHARK® and is available from Cerex Advanced Fabrics, Inc. According to many embodiments of the subject invention, a thermally bonded fabric can be bonded over about 17% to 25% of the fabric area. These bond points are not porous and are actually tiny areas of almost solid melted nylon in the fabric making the fabric less open. Other patterns can be used. Examples of fabrics that can be used with other patterns are a diamond patterned fabric sold under the trademarks ORION® and OIL SHARK® available from Cerex Advanced Fabrics, Inc. and a herringbone patterned fabric sold under the trademarks SPECTRAMAX® and OIL SHARK® available from Cerex Advanced Fabrics, Inc.

In another preferred embodiment, the nonwoven fabric has a basis weight of 4 osy as measured by ASTM test method D3776, thickness of about 22.3 mils as measured using ASTM D1777,machine direction grab tensile strength of at least about 157 lbs_{f} as measured using ASTM D5034, machine direction grab elongation of about 91% as measured using ASTM D5034, cross direction grab tensile strength of at least about 119 lbs_{f} as measured using ASTM D5034, cross direction grab elongation of about 100% as measured using ASTM D5034, machine direction trapezoidal tear strength of at least about 49 lbs_{f} as measured by ASTM D5587, cross direction trapezoidal tear strength of at least about 34.2 lbs_{f} measured by ASTM D5587, air permeability of at about 125 ft³/min/ft² as measured by ASTM D737, a burst strength of at least about 109.4 PSI as measured by ASTM D3786, a mean pore size of about 31 microns, retention of at least about 87% of its machine direction grab strength as measured using ASTM D5034 when exposed to a xenon light source for 1000 hours, continuous nylon filaments, and wicks oil and water. This fabric will also pass the criteria for SW-846, Third Edition which is the EPA standard for allowing wastes to be treated as non-hazardous waste.

A nonwoven fabric used in an oil containment or separation fence system can have a flux rate, or function to filter water with a flux rate, as measured by ASTM D5141, of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values are in gallons per minute per square foot (gpm/ft²)): 0.01, 0.02, 0.03, 0.04, 0.05, 0.06, 0.07, 0.1, 0.2, 0.3, 0.4, 0.5, 0.6, 0.7, 0.8, 0.9, 0.91, 0.92, 0.93, 0.94, 0.95, 0.96, 0.97, 0.98, 0.99, 1.0, 1.05, 1.10, 1.15, 1.19, 1.20, 1.21, 1.25, 1.3, 1.4, 1.5, 1.75, 2.0, 2.5, 3.0, 3.5, 4.0, 5, 6, 7, 8, 9, 10, 15, 20, 25, or 30. For example, a nonwoven fabric can have can have a flux rate, or function to filter water with a flux rate, as measured by ASTM D5141, of 0.91 gpm/ft², about 0.91 gpm/ft², 0.94 gpm/ft², about 0.94 gpm/ft², 0.96 gpm/ft², about 0.96 gpm/ft², 1.2 gpm/ft², or about 1.2 gpm/ft². In particular embodiments, a nonwoven fabric can have can have a flux rate, or function to filter water with a flux rate, as measured by ASTM D5141, of at least 0.91 gpm/ft², at least 0.94 gpm/ft², at least 0.96 gpm/ft², or at least 1.2 gpm/ft².

A nonwoven fabric used in an oil containment fence system can have a filter efficiency (e.g., as measured by ASTM D5141) of, for example, any of the following values, about any of the following values, at least any of the following values, at least about any of the following values, not more than any of the following values, not more than about any of the following values, or within any range having any of the following values as endpoints (with or without “about” in front of one or both of the endpoints), though embodiments are not limited thereto (all numerical values given are in %): 5, 10, 15, 20, 25, 30, 35, 40, 45, 50, 55, 60, 65, 70, 75, 80, 85, 86, 90, 91, 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, 99.99, or 100. For example, a nonwoven fabric can have a filter efficiency, as measured by ASTM D5141, of 99%, about 99%, at least 99%, 99.1%, about 99.1%, at least 99.1%, 99.3%, about 99.3%, at least 99.3%, 99.5%, about 99.5%, or at least 99.5%. In a particular embodiment, a nonwoven fabric can have a filter efficiency, as measured by ASTM D5141, of at least 99%. A nonwoven fabric can have a filter efficiency, as measured by ASTM D5141, of any of the following values or ranges as discussed in this paragraph even when filtering fluid (e.g., water) at a flux rate of any of the values or ranges as discussed in the previous paragraph (e.g., at least 0.91 gpm/ft², at least 0.94 gpm/ft², at least 0.96 gpm/ft², or at least 1.2 gpm/ft²). The protocol for ASTM D5141 used to measure the filter efficiency and flux rate is described in detail in a publication by Wolfe et al. (Wolfe, K. B. and Peters, J. L., Qualitative Valuation of Performance Testing for Sediment Retention Devices, International Erosion Control Association, http://www.ieca.org/membersonly/cms/content/Proceedings/Obj ect463PDFEnglish.pdf), which is hereby incorporated by reference in its entirety.

Woven fabrics can also be used but they are typically more expensive to manufacture and can unravel or leave frayed edges when cut or deployed. This would lead to fiber migration allowing undesirable material into the environment. Binding would most likely need to be added to the edges of the woven fabrics increasing the cost of the fence fabric.

In yet another embodiment, a fabric has a basis weight of 1.5 osy as measured by ASTM test method D3776, thickness of about 6.9 mils as measured using ASTM D1777, machine direction grab tensile strength of at least about 58 lbs_{f} as measured using ASTM D5034, machine direction grab elongation of about 54% as measured using ASTM D5034, cross direction grab tensile strength of at least about 38 lbs_{f} as measured using ASTM D5034, cross direction grab elongation of about 61% as measured using ASTM D5034, machine direction trapezoidal tear strength of at least about 14 lbs_{f} as measured by ASTM D5587, cross direction trapezoidal tear strength of at least about 10 lbs_{f} measured by ASTM D5587, a burst strength of at least about 50 PSI as measured by ASTM D3786, a mean pore size of about 32.3 microns, air permeability of about 277 ft³/min/ft² as measured by ASTM D737, continuous nylon filaments, and wicks oil and water. The fabric is chemically bonded as described in U.S. Pat. No. 3,516,900 and U.S. Pat. No. 4,168,195. The surface of this fabric is smooth with no point bonds. Other polymers including but not limited to polyester and polypropylene can be used to make a similar fabric. The fabric can be made from filaments that comprise more than one polymer such as bicomponent or tricomponent filaments. This fabric is sold under the trademarks Cerex® and OIL SHARK® and is available from Cerex Advanced Fabrics, Inc.

In a specific embodiment a 4 osy nylon fabric is used. This fabric is available from Cerex Advanced Fabrics, Inc, under the trade name Oil Shark® Type 30. The advantages that the Oil Shark® fabric has is that the mean pore size of Oil Shark® 4 osy fabric is lower than similar fabrics of the same basis weight, the nylon Oil Shark® 4 osy fabric is hydrophilic creating an attractive motive force to draw the emulsion towards it, the burst strength of the Oil Shark® 4 osy fabric is higher than comparable fabrics giving the Oil Shark® 4 osy fabric the ability to withstand higher pressures than most fabrics that are the same basis weights, fabrics that have as high a strength as the Oil Shark® 4 osy fabric will tend to be much heavier limiting the length of rolls that can be deployed on sites because of Occupational Safety and Health Administration (OSHA) regulations, nylon fabrics absorb oils of a wide range of viscosities and the 4 denier per filament (23.7 micron diameter filament) wicks oil and water well. This fabric will pass the criteria for SW-846, Third Edition which is the EPA standard for allowing wastes to be treated as non-hazardous waste.

Dyes or other materials that impart high visibility colors (e.g., orange and red) commonly include hazardous materials, for example, metals such as hexavalent chromium and/or lead. Only a few materials exist that that can impart high visibility colors, do not contain these hazardous materials, and can tolerate the high temperatures required in processing polymer pellets into fabrics. In certain embodiments, a nonwoven fabric used in an oil containment or separation fence system as described herein can include one or more dyes or other materials, thereby resulting in a nonwoven fabric with a high visibility color (e.g., orange or red). Such a dye or other material does not contain hazardous materials, such as hexavalent chromium or lead. In a particular embodiment, a combination of a solvent red dye and a solvent orange dye can be added to a nylon extrusion system to make a strong nonwoven fabric with a high visibility color (orange or orange-ish) that can be used to provide an oil containment or separation fence system made of a single layer of nonwoven fabric that does not tear during installation or when holding back the flow of water. This fabric will also pass the criteria for SW-846, Third Edition, which is the EPA standard for allowing wastes to be treated as non-hazardous waste.

The nonwoven fence fabric can be deployed as an oil containment or separation fence by placing stakes or posts (or other support elements, including but not limited to trees) in the ground and fastening the fabric to the stakes. The stakes or posts can be inserted in the ground in the body of water where the fabric is to be deployed as a fence. The fence can be installed, for example, with the fabric about six inches or more above the water. If the water level will rise during a rain event the fabric must be installed the appropriate height above the water to accommodate the rise in level so as not to allow oil to pass over the fence, especially since crude oil will frequently float on the surface of the water. The fabric can also be installed on land or on a shoreline. The fabric can be fastened to the posts and stakes by a number of means including using ties, string, baling wire, rope, straps or other fastening devices known in the art. For the sake of this invention, straps are defined as being made from strips of fabric, film, hook and loop fastening devices such as Velcro® straps or a combination of them such as hook and loop fastening devices attached to a strip of fabric. Straps can be made from any kind of fabric including but not limited to nonwoven fabric, woven fabric, or knit fabric. Using nonwoven spunbond fabric provides the advantage of eliminating fiber migration because it does not fray or have loose filaments when this fabric is cut.

In a preferred embodiment, straps are attached to the fence fabric and tied to the stakes or posts. The straps can be sewn, laminated with an adhesive, glued, melted by various means such as a calendering process, or ultrasonically welded to the fence fabric. In a preferred embodiment, the straps are sewn to the fabric. In another preferred embodiment, the straps are ultrasonically welded to the fabric.

The straps can be made from material or fabric that is made with the same polymer as the fence fabric, from material or fabric that is made from a different polymer than the fence fabric or a combination of two or more polymers, one of them being the same as the polymer used to make the fence fabric or all of them being different than the polymer used to make the fence fabric. In a preferred embodiment, the straps are made from fabric that is made with the same polymer as the fence fabric. In another preferred embodiment, both the fence fabric and the straps are made using nylon polymer. In yet another preferred embodiment, both the straps and the fence fabrics are made using polyester terephthalate polymer.

The straps used to attach the fence fabric to posts or stakes can be made from material with the same basis weight as the fence fabric or material that has a different basis weight as the fence fabric. The straps can be made from fabric that has a higher basis weight than the fence fabric. The straps can be made from fabric that has the same basis weight as the fence fabric. The straps can also be made from fabric that is of a lower basis weight than the fence fabric. For example, the straps can be made from a fabric that has a basis weight that is about 90% to about 100% of the basis weight of the fence fabric, a basis weight that is about 80% to about 90% of the basis weight of the fence fabric, a basis weight that is about 70% to about 80% of the basis weight of the fence fabric, a basis weight that is about 60% to about 70% of the basis weight of the fence fabric, a basis weight that is about 50% to about 60% of the basis weight of the fence fabric, a basis weight that is about 40% to about 50% of the basis weight of the fence fabric, a basis weight that is about 30% to about 40% of the basis weight of the fence fabric, a basis weight that is about 20% to about 30% of the basis weight of the fence fabric, a basis weight that is about 10% to about 20% of the basis weight of the fence fabric or a basis weight that is about 1% to about 10% of the basis weight of the fence fabric. One skilled in the art will realize that typically, the higher the basis weight of the fabric the higher the cost of the fabric. In a preferred embodiment, the fence fabric is made from a 4 ounce per square yard fabric and the straps are made from a 4 ounce per square yard fabric. In another preferred embodiment, the fence fabric is made from a 4 osy fabric and the straps are made from a 3 osy fabric. In yet another preferred embodiment, the fence fabric is made from a 4 osy fabric and the straps are made from a 2 osy fabric.

The straps used to attach the fence fabric to stakes or posts can be of any color including but not limited to black, white, off-white, red, orange, yellow, green, blue, indigo or purple. Fluorescent additives, optical brighteners, antioxidants, ultraviolet light stabilizers, antimicrobials and other additives that impart unique properties to fabrics can be included in or on the fabric to provide a more vibrant appearance, light stability, antimicrobial performance and other enhanced properties to the straps. More than one additive can be included in the fabric to provide more than one enhanced property. Information can also be printed on the straps such as logos and websites. In a preferred embodiment the web site address “www.oilshark.com” is printed on the straps along with the OIL SHARK® logo which is a picture of a shark.

The straps can be of any width that allows the fabric to be attached to posts and still allows the fence to maintain its integrity and not fail when in use including during a rain event. The straps can be about 1/16 of an inch wide to about 4 inches wide or wider. For example, the straps can be between about 1/16 inch and about ¼ inches wide, between about ¼ inches and about ½ inches wide, between about ½ inch and about ¾ inches wide, between about ¾ inches and about 1 inch wide, between about 1 inch and about 1¼ inches wide, between about 1¼ inches and about 1½ inches wide, between about 1½ inches and about 1¾ inches wide, between about 1¾ inches and about 2 inches wide, between about 2 inches and about 3 inches wide, between about 3 inches and about 4 inches wide or more than about 4 inches wide. The wider the strap of fabric the higher the cost of the material used to make the strap so there is an incentive to keep the strap as thin as is required to accomplish the task of attaching the fence fabric to the post or stake without failure. In a preferred embodiment, the straps are between about ½ inches wide to about 1 inch wide. In another preferred embodiment, the straps are between about ¾ inches wide to about 2 inches wide. In another embodiment, the straps are between about 2 inches wide to about 6 inches wide.

The straps must be long enough to allow the installer to tie the straps and fence to the stakes or post. The length of the straps can be between about 1 inch and about 3 inches, between about 3 inches and about 4 inches, between about 4 inches and about 5 inches, between about 5 inches and about 6 inches, between about 6 inches and about 8 inches, between about 8 inches and about 10 inches, between about 10 and about 12 inches, between about 12 and about 14 inches, between about 14 and about 16 inches or greater than about 16 inches. In a preferred embodiment, the straps are longer than about 6 inches. In another preferred embodiment, the straps are between about6 inches and about 15 inches. In yet another preferred embodiment, the straps are between about 6 inches and about 10 inches. In yet another preferred embodiment, the straps are not cut and are of a continuous length attached longitudinally along the fabric in parallel rows. This continuous strap can also be perforated to allow the installer to tear the strap in order to have two ends for adjacent locations where the straps can be tied to the posts or stakes. This eliminates the need to carry any cutting tool, like a scissors or knife to cut the straps to tie the fabric to posts or stakes. The fence fabric can then be installed without the use of tools.

The straps fastened on the highest portion of the fence fabric can be installed as close to the top of the fence fabric as is practical. These straps can be installed about ¼ of an inch from the top of the fabric, about ¼ inch to about 1 inch from the top of the fabric, about 1 inch to about 2 inches from the top of the fabric, about 2 inches to about 3 inches from the top of the fabric, about 3 inches to about 4 inches from the top of the fabric, about 4 inches to about 5 inches from the top of the fabric, about 5 inches to about 6 inches from the top of the fabric, about 6 inches to about 10 inches from the top of the fabric, or about 10 inches to about 15 or more then about 15 inches from the top of the fabric. In a preferred embodiment, the straps fastened on the highest potion of the fence fabric are about 1 inch to about 4 inches from the top of the fence fabric. In another preferred embodiment, the straps are fastened to the fence fabric about 2 inches from the top of the fence fabric.

At least two straps per pole or stakes can be attached on the fence fabric and tied to the pole or stakes. The straps do not have to be in even rows longitudinally across the length of the fence fabric. If continuous straps are used then at least two continuous rows of straps in the longitudinal direction can be attached to the fence fabric. In a preferred embodiment, three rows of discrete straps are fastened to the fence fabric about every 30 inches in length of the fabric by sewing 20 inch straps to the fabric. In another preferred embodiment, three rows of continuous straps are sewn to the fence fabric with a sewn seam occurring about every 30 inches in each of the three rows. In another preferred embodiment, three rows of continuous straps are ultrasonically welded to the fence fabric with a weld occurring about every 30 inches in each of the three rows. In another preferred embodiment the distance between the rows of straps are at least about 6 inches apart to about 25 inches apart. It is not a requirement for the distances between the rows of straps to be identical. For example, the distance from the top to the middle row can be about 10 to about 15 inches, whereas, the distance from the middle row to the bottom row can be about 6 to about 10 inches.

The distance between the locations where the straps are fastened to the fence fabric and the number of rows of straps is determined by the environment the oil separation or containment fence is to be deployed into. If the fence is deployed on land or on the shoreline the main concern is a rainwater event. If the fence is deployed into a fast moving stream, more rows of straps may be employed and the distance between the posts may be closer than what is typically used when deploying the fence in a calm stream. The straps will need to be closer together to match the distance between posts or stakes when the fence is deployed. The distance between the locations where the straps are fastened to the fence fabric can be between about 4 inches to about 10 inches, between about 10 inches to about 15 inches, between about 15 inches to about 20 inches, between about 20 inches to about 25 inches, between about 25 inches to about 30 inches, between about 30 inches and about 35 inches, between about 35 inches and about 40 inches, between about 40 inches and about 45 inches, between about 45 inches and about 50 inches or more than about 50 inches. In a preferred embodiment, the distance between the locations where the straps are fastened to the fence fabric is between about 15 to about 30 inches. In another preferred embodiment, the distance between the locations where the straps are fastened to the fence fabric is between about 20 to about 50 inches. In yet another preferred embodiment, the distance between the locations where the straps are fastened to the fence fabric is between about 24 inches and 30 inches. For added strength and to prevent straps from tearing or breaking, the fence fabric can be rolled onto the first and last post or stake. The fabric can be rolled ½ or more revolutions around these end posts or stakes. If the straps are continuous and perforated, then the ideal distance between perforations of the straps will be half the distance of the distance between the locations where the straps are fastened to the fence fabric. While this is an ideal this is not a requirement. A fence can also be fabricated with straps that are not perforated symmetrically. In a preferred embodiment, the straps are perforated every 20 inches. In another preferred embodiment the straps are perforated every 30 inches.

The strength of the seam that is used to attach the straps to the fabric must be sufficient to prevent the straps from tearing off the fabric. The shape and size of the seam is not critical as long as the seam holds the strap to the fabric. The seam can be a sewn seam, an adhesive seam, a melted seam, an ultrasonic seam or another type of seam created by any technology known in the art. The seam strength can be greater than the tensile strength of the fabric, the same as the tensile strength of the fabric or somewhat less than the tensile strength of the fabric. For example, the tensile strength of the seam can be at least about 150% greater than the tensile strength of the fabric, between about 100% to about 50% greater than the tensile strength of the fabric, between about 90% to about 100% of the tensile strength of the fence fabric, between about 80% to about 90% of the tensile strength of the fence fabric, between about 70% to about 80% of the tensile strength of the fence fabric, between about 60% to about 70% of the tensile strength of the fence fabric, between about 50% to about 60% of the tensile strength of the fence fabric, between about 0% to about 50% of the tensile strength of the fence fabric, between about 30% to about 40% of the tensile strength of the fence fabric, between about 20% to about 30% of the tensile strength of the fence fabric, between about 10% to about 20% of the tensile strength of the fence fabric or between about 1% to about 10% of the tensile strength of the fence fabric. In a preferred embodiment, the tensile strength of the seam is the same as the tensile strength of the fabric.

The thread used to make the seam can be made from any polymer. The thread must be able to maintain its integrity and strength and not degrade in water or spilled oil or both. The sewing thread can include additives to provide enhanced properties to the thread. For example, the seaming thread can be made with an additive that inhibits degradation caused by ultraviolet light or the seaming thread can be coated with material that can inhibit degradation caused by ultraviolet light. Seaming thread made of nylon, cotton, polyester, polypropylene or a combination of these materials can be used to sew the straps to the fence fabric. The thread can be of any color. In an embodiment, cotton sewing thread is used. In another embodiment, green cotton sewing thread can be used. In a preferred embodiment, nylon sewing thread is used. In another preferred embodiment, black nylon sewing thread can be used.

In certain embodiments, the top edge of the fabric can be folded over at least once and at least one seam can be sewn into it to provide a stronger edge to fasten stakes, posts or other supporting hardware to the fabric. As many folds and/or seams as may be desired can be included. It is also possible to sew a pocket seam on the top edge of the fabric to accommodate the top of a stake. If not at an edge, any number of even folds can be made parallel to the ground to provide a thicker, stronger section to fasten the stakes or other apparatus if so desired. At least one fold can also be made at the bottom edge and slits can be cut or posts or stakes can be driven through the bottom of the fence fabric into the edge to slide stakes or other hardware used to install the system in the ground. As many bottom edge folds and/or slits as may be desired can be included.

In another embodiment, the fence can be installed in a stream, river or other flowing water system approximately two or more inches above the floor level to allow the flow of water to run under the fence. Since crude oil will float to the surface of the flowing water system only water without oil will pass below the bottom of the fence.

In other embodiments, a sleeve to accommodate a post or a stake can be fastened to the fence fabric perpendicular to the installed longitudinal length of the fence fabric. The sleeve can be made from material with the same basis weight as the fence fabric or material that has a different basis weight as the fence fabric. The sleeves can be made from fabric that has a higher basis weight than the fence fabric. The sleeves can be made from fabric that has the same basis weight as the fence fabric. The sleeves can also be made from fabric that is of a lower basis weight than the fence fabric.

Similar to the straps, the sleeves can be of any color, and vary in width and length. Strength of the seam used to attach the sleeve must be high enough to prevent the sleeve from detaching from the fence during severe conditions such as a rain event. The distance between the locations where the sleeves are fastened to the fence fabric can be between about 5 inches to about 10 inches, between about 10 inches to about 15 inches, between about 15 inches to about 20 inches, between about 20 inches to about 25 inches, between about 25 inches to about 30 inches, or more than about 30 inches. In a preferred embodiment, the distance between the locations where the sleeves are fastened to the fence fabric is between about 15 to about 30 inches. In another preferred embodiment, the distance between the locations where the sleeves are fastened to the fence fabric is between about 20 to about 50 inches.

A second layer of fence fabric can be installed on the opposite side of the current installation to provide a double fence for added protection to the environment preventing any pass through of oil because of tides or rain events. It is not a requirement for the second layer to be the same as the original, installed fence fabric if it is for added protection. Containment of oil can be accomplished during a change over by attaching the fence fabric to the opposite side of the stakes or posts without adding more posts or stakes.

In yet another embodiment, the fence fabric can be attached to posts or stakes by installing grommets in the fence fabric. Grommets can be installed instead of straps in the precise locations where the straps would have been installed. The same considerations and embodiments apply to the means that use grommets as with the means that use straps, i.e., all the embodiments listed for the means that use the straps apply for the means that use grommets. Using grommets is typically more expensive and also presents the problem of allowing small quantities of spilled oil to leak through the holes created by the grommets.

In yet another embodiment, a recyclable tape measure made from the same material as the straps can be provided as a guide for determining the distance between the posts and stakes.

In certain embodiments, the distance between the posts or stakes can vary along the length of the fence fabric during installation. Also, the length of the straps does not have to be constant or the same along the length of the fence fabric.

The subject invention includes, but is not limited to, the following exemplified embodiments.

Embodiment 1. An oil containment/separation fence, comprising:

a fence nonwoven fabric; and

fasteners configured to attach the fence nonwoven fabric to support elements.

Embodiment 2. The oil containment/separation fence according to embodiment 1, wherein the fasteners comprise straps integrally formed with the fence nonwoven fabric.

Embodiment 3. The oil containment/separation fence according to any of embodiments 1-2, wherein the fasteners comprise grommets within the fence nonwoven fabric.

Embodiment 4. The oil containment/separation fence according to embodiment 1, wherein the fasteners comprise both: straps integrally formed with the fence nonwoven fabric; and grommets within the fence nonwoven fabric.

Embodiment 5. The oil containment/separation fence according to any of embodiments 1-4, further comprising a plurality of support elements supporting the fence nonwoven fabric, wherein the fasteners are fastened to the plurality of support elements.

Embodiment 6. The oil containment/separation fence according to embodiment 5, wherein each support element is a post or a stake.

Embodiment 7. The oil containment/separation fence according to embodiment 6, wherein each support element is a post, a stake, or a tree.

Embodiment 8. The oil containment/separation fence according to any of embodiments 1-7, wherein the fence nonwoven fabric comprises nylon.

Embodiment 9. The oil containment/separation fence according to any of embodiments 1-8, wherein the fence nonwoven fabric comprises polyester.

Embodiment 10. The oil containment/separation fence according to any of embodiments 1-9, wherein the fence nonwoven fabric comprises polypropylene.

Embodiment 11. The oil containment/separation fence according to any of embodiments 5-10, wherein the fence nonwoven fabric is supported by the plurality of support elements such that, when in use in a body of water and the support elements are in the ground, a top portion of the nonwoven fabric is at least six inches above the body of water.

Embodiment 12. The oil containment/separation fence according to any of embodiments 1-11, wherein the fasteners comprise the straps integrally formed with the fence nonwoven fabric, and wherein the straps are sewn, laminated with an adhesive, glued, melted by a calendering process, or ultrasonically welded to the fence nonwoven fabric.

Embodiment 13. The oil containment/separation fence according to any of embodiments 1-12, wherein the fasteners comprise the straps integrally formed with the fence nonwoven fabric, and wherein the straps and the fence nonwoven fabric comprise the same polymer.

Embodiment 14. A method of fabricating an oil containment/separation fence, the method comprising:

fabricating a fence nonwoven fabric; and

fabricating straps attached to the fence nonwoven fabric and configured to be fastened to a plurality of support elements for supporting the nonwoven fabric,

wherein fabricating the fence nonwoven fabric comprises:

feeding and spinning, in an extruder, one or more polymer resins;

extruding the one or more polymer resins in the form of a plurality of filaments;

depositing the filaments onto a collection surface to form a web; and

thermally bonding the filaments of the web to form the fence nonwoven fabric.

Embodiment 15. A method of fabricating an oil containment/separation fence, the method comprising:

fabricating a fence nonwoven fabric;

inserting a plurality of support elements into the ground within a body of water, near a body of water, or both; and

attaching the fence nonwoven fabric to the plurality of support elements, such that the plurality of support elements support the fence nonwoven fabric,

wherein fabricating the fence nonwoven fabric comprises:

feeding and spinning, in an extruder, one or more polymer resins;

extruding the one or more polymer resins in the form of a plurality of filaments;

depositing the filaments onto a collection surface to form a web; and

thermally bonding the filaments of the web to form the fence nonwoven fabric,

Embodiment 16. The method according to embodiment 15, wherein the fence nonwoven fabric is attached to the plurality of support elements using fasteners, the fasteners comprising straps integrally formed with the fence nonwoven fabric, grommets within the fence nonwoven fabric, or both.

Embodiment 17. The method according to any of embodiments 14-16, wherein each support element is a stake or a post.

Embodiment 18. The method according to any of embodiments 14-16, wherein each support element is a stake, a post, or a tree.

Embodiment 19. The oil containment/separation fence according to any of embodiments 1-13 or the method according to any of embodiments 14-18, wherein the fence nonwoven fabric passes the criteria for United States Environmental Protection Agency (EPA) SW-846, Third Edition.

Embodiment 20. The oil containment/separation fence according to any of embodiments 1-13 and 19 or the method according to any of embodiments 14-19, wherein the fence nonwoven fabric has a machine direction grab tensile strength of at least 58 lbs_{f} as measured using American Society for Testing and Materials test method (ASTM) D5034.

Embodiment 21. The oil containment/separation fence according to any of embodiments 1-13 and 19-20 or the method according to any of embodiments 14-20, wherein the fence nonwoven fabric has a cross direction grab tensile strength of at least 38 lbs_{f} as measured using ASTM D5034

Embodiment 22. The oil containment/separation fence according to any of embodiments 1-13 and 19-21 or the method according to any of embodiments 14-22, wherein the fence nonwoven fabric has a machine direction trapezoidal tear strength of at least 14 lbs_{f} as measured by ASTM D5587.

Embodiment 23. The oil containment/separation fence according to any of embodiments 1-13 and 19-22 or the method according to any of embodiments 14-22, wherein the fence nonwoven fabric has a cross direction trapezoidal tear strength of at least 10 lbs_{f} as measured by ASTM D5587.

Embodiment 24. The oil containment/separation fence according to any of embodiments 1-13 and 19-23 or the method according to any of embodiments 14-23, wherein the fence nonwoven fabric has a basis weight of at least 1.5 ounces per square yard (osy) as measured using ASTM D3776.

Embodiment 25. The oil containment/separation fence according to any of embodiments 1-13 and 19-24 or the method according to any of embodiments 14-24, wherein the fence nonwoven fabric has a machine direction grab elongation of about 84% as measured using ASTM D5034.

Embodiment 26. The oil containment/separation fence according to any of embodiments 1-13 and 19-25 or the method according to any of embodiments 14-25, wherein the fence nonwoven fabric has a cross direction grab elongation of about 94% as measured using ASTM D5034.

Embodiment 27. The oil containment/separation fence according to any of embodiments 1-13 and 19-27 or the method according to any of embodiments 14-27, wherein the fence nonwoven fabric has an air permeability of no more than277 ft³/min/ft² as measured by ASTM D737.

Embodiment 28. The oil containment/separation fence according to any of embodiments 1-13 and 19-27 or the method according to any of embodiments 14-27, wherein the fence nonwoven fabric has a burst strength of at least 50 pounds per square inch (psi) as measured by ASTM D3786.

Embodiment 29. The oil containment/separation fence according to any of embodiments 1-13 and 19-29 or the method according to any of embodiments 14-29, wherein the fence nonwoven fabric has a mean pore size of no more than 34.1 microns.

Embodiment 30. The oil containment/separation fence according to any of embodiments 1-13 and 19-29 or the method according to any of embodiments 14-29, wherein the fence nonwoven fabric has a retention of at least 87% of its machine direction grab strength as measured using ASTM D5034 when exposed to a xenon light source for 1000 hours.

Embodiment 31. The oil containment/separation fence according to any of embodiments 1-13 and 19-30 or the method according to any of embodiments 14-30, wherein the fence nonwoven fabric has a basis weight of 4 about osy as measured by as measured by American Society for Testing and Materials test method (ASTM) D3776.

Embodiment 32. The oil containment/separation fence according to any of embodiments 1-13 and 19-31 or the method according to any of embodiments 14-31, wherein the fence nonwoven fabric has a thickness of about 22.3 mils as measured using ASTM D1777.

Embodiment 33. The oil containment/separation fence according to any of embodiments 1-13 and 19-32 or the method according to any of embodiments 14-32, wherein the fence nonwoven fabric has a machine direction grab tensile strength of at least 58 lbs_{f} as measured using ASTM D5034.

Embodiment 34. The oil containment/separation fence according to any of embodiments 1-13 and 19-33 or the method according to any of embodiments 14-3, wherein the fence nonwoven fabric has a machine direction grab elongation of about 91% as measured using ASTM D5034.

Embodiment 35. The oil containment/separation fence according to any of embodiments 1-13 and 19-34 or the method according to any of embodiments 14-34, wherein the fence nonwoven fabric has wherein the fence nonwoven fabric has a cross direction grab tensile strength of at least about 38 lbs_{f} as measured using ASTM D5034.

Embodiment 36. The oil containment/separation fence according to any of embodiments 1-13 and 19-35 or the method according to any of embodiments 14-35, wherein the fence nonwoven fabric has a cross direction grab elongation of about 100% as measured using ASTM D5034.

Embodiment 37. The oil containment/separation fence according to any of embodiments 1-13 and 19-36 or the method according to any of embodiments 14-36, wherein the fence nonwoven fabric has a machine direction trapezoidal tear strength of at least 14 lbs_{f} as measured by ASTM D5587.

Embodiment 38. The oil containment/separation fence according to any of embodiments 1-13 and 19-37 or the method according to any of embodiments 14-37, wherein the fence nonwoven fabric has an air permeability of about 125 ft³/min/ft² as measured by ASTM D737.

Embodiment 39. The oil containment/separation fence according to any of embodiments 1-13 and 19-38 or the method according to any of embodiments 14-38, wherein the fence nonwoven fabric has a burst strength of at least 109.4 psi as measured by ASTM D3786,

Embodiment 40. The oil containment/separation fence according to any of embodiments 1-13 and 19-39 or the method according to any of embodiments 14-39, wherein the fence nonwoven fabric has a mean pore size of about 31 microns.

Embodiment 41. The oil containment/separation fence according to any of embodiments 1-13 and 19-40 or the method according to any of embodiments 14-40, wherein the fence nonwoven fabric has a machine direction grab tensile strength of at least 115 lbs_{f} as measured using ASTM D5034.

Embodiment 42. The oil containment/separation fence according to any of embodiments 1-13 and 19-41 or the method according to any of embodiments 14-41, wherein the fence nonwoven fabric has a cross direction grab tensile strength of at least 86 lbs_{f} as measured using ASTM D5034.

Embodiment 43. The oil containment/separation fence according to any of embodiments 1-13 and 19-42 or the method according to any of embodiments 14-42, wherein the fence nonwoven fabric has a machine direction trapezoidal tear strength of at least 35 lbs_{f} as measured by ASTM D5587.

A greater understanding of the present invention and of its many advantages may be had from the following examples, given by way of illustration. The following examples are illustrative of some of the methods, applications, embodiments and variants of the present invention. They are, of course, not to be considered as limiting the invention. Numerous changes and modifications can be made with respect to the invention.

### EXAMPLE 1

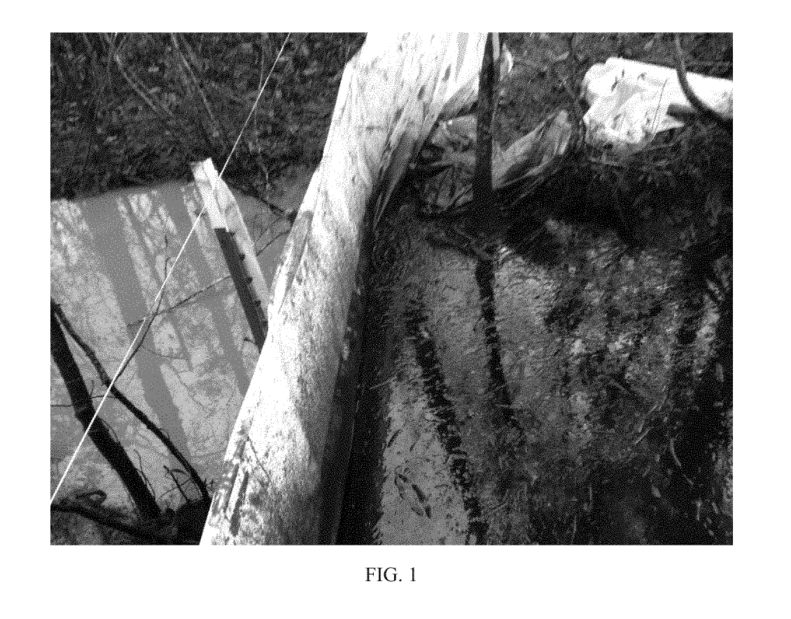

Crude oil was spilled from a derailed tank car and mixed in a stream. A 4 osy fabric was used to deploy an oil containment fence. Stakes were placed in the ground at the edge of and in the stream. The fabric was attached to the posts with fabric strips and wire. Oil was contained on the upstream side of the fence. FIG. 1 illustrates the prior art method of installing a fence in a stream.

### EXAMPLE 2

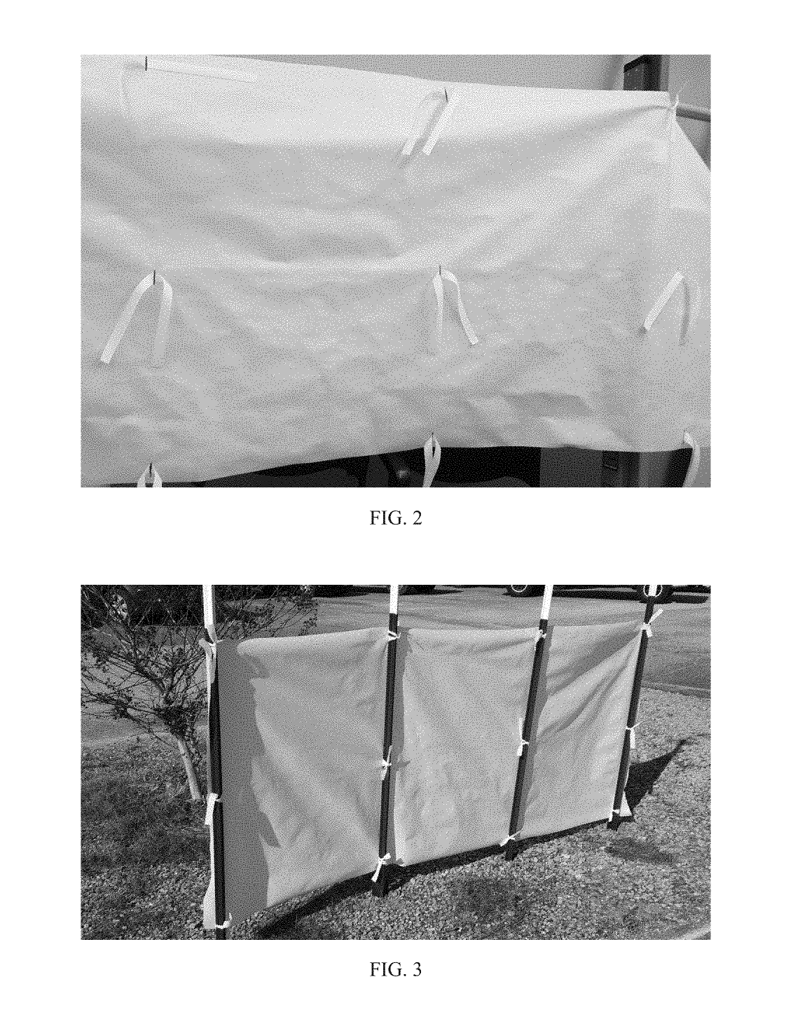

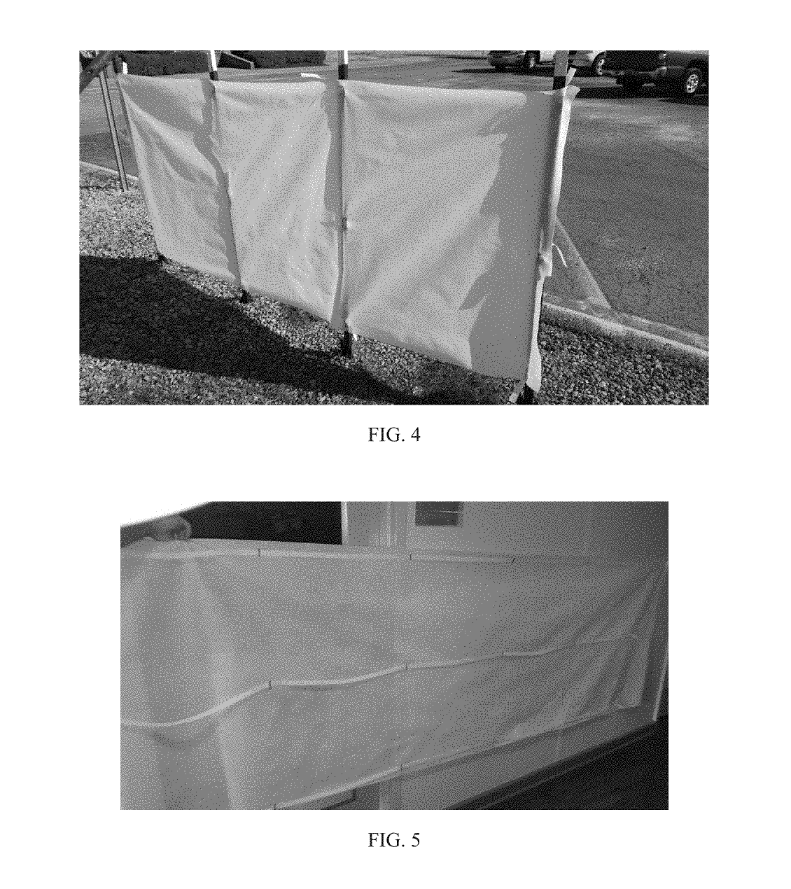

According to an embodiment of the subject invention, straps made from a 4 osy nylon spunbond fabric available from Cerex Advanced Fabrics, Inc. under the trade name OIL SHARK® and PBN-II® were attached to a similar fabric made into a fence that can separate oil from water. Three rows of straps were fastened to the fence fabric. The straps were about ¾ inches wide and 20 inches long. The straps were fastened in the longitudinal direction about 30 inches apart. The center of the top straps was fastened 2 inches from the top of the fabric. The next row of straps was fastened 19 inches center to center from the top row of straps. Finally, the bottom row of straps was fastened to the fence fabric 18 inches center to center from the middle row of straps and 1 ½ inches from the bottom of the fabric. FIG. 2 is an illustration of the fence fabric with straps fastened to it. FIGS. 3 and 4 show the fence fabric with straps attached to it installed on land. No tools were used in this installation. The straps were tied to the posts using a square knot.

### EXAMPLE 3

According to an embodiment of the subject invention, straps made from a 4 osy nylon spunbond fabric available from Cerex Advanced Fabrics, Inc. under the trade name OIL SHARK® and PBN-II® were attached to a similar fabric made into a fence that can separate oil from water. FIG. 5 is an illustration of the fence fabric with perforated, continuous straps. The fence fabric with perforated, continuous straps fastened to it was installed on land.

Three rows of perforated, continuous straps were fastened to the fence fabric. A perforation on these continuous straps was located every 24 inches. The continuous straps were about ¾ inches wide and continuous. The rows of straps were fastened in the longitudinal direction about 24 inches apart. The center of the top straps was fastened 2 inches from the top of the fabric. The next row of straps was fastened 19 inches center to center from the top row of straps. Finally, the bottom row of straps was fastened to the fence fabric 18 inches center to center from the middle row of straps and 1 ½ inches from the bottom of the fabric. No tools were used in this installation. The straps were pulled apart where the perforation was and tied to the posts using a square knot.

It should be understood that the examples and embodiments described herein are for illustrative purposes only and that various modifications or changes in light thereof will be suggested to persons skilled in the art and are to be included within the spirit and purview of this application and the scope of the appended claims.

All patents, patent applications, provisional applications, and publications referred to or cited herein (including those in the “References” section, if present) are incorporated by reference in their entirety, including all figures and tables, to the extent they are not inconsistent with the explicit teachings of this specification.

What is claimed is:

1. An oil containment/separation fence, comprising:
a fence nonwoven fabric; and
fasteners configured to attach the fence nonwoven fabric to support elements, wherein the fasteners comprise at least one of the following types of fastener: straps integrally formed with the fence nonwoven fabric; and grommets within the fence nonwoven fabric.

2. The oil containment/separation fence according to claim 1, further comprising a plurality of support elements supporting the fence nonwoven fabric, wherein the fasteners are fastened to the plurality of support elements.

3. The oil containment/separation fence according to claim 2, wherein each support element is a post or a stake.

4. The oil containment/separation fence according to claim 1, wherein the fence nonwoven fabric has a machine direction grab tensile strength of at least 58 lbs_{f} as measured using American Society for Testing and Materials test method (ASTM) D5034, a cross direction grab tensile strength of at least 38 lbs_{f} as measured using ASTM D5034, a machine direction trapezoidal tear strength of at least 14 lbs_{f} as measured by ASTM D5587, and a cross direction trapezoidal tear strength of at least 10 lbs_{f} as measured by ASTM D5587.

5. The oil containment/separation fence according to claim 1, wherein the fence nonwoven fabric passes the criteria for United States Environmental Protection Agency (EPA) SW-846, Third Edition.

6. The oil containment/separation fence according to claim 1, wherein the fence nonwoven fabric has a basis weight of at least 1.5 ounces per square yard (osy) as measured using ASTM D3776.

7. The oil containment/separation fence according to claim 1, wherein the fence nonwoven fabric has a machine direction grab elongation of about 84% as measured using ASTM D5034, and wherein the nonwoven fabric has a cross direction grab elongation of about 94% as measured using ASTM D5034.

8. The oil containment/separation fence according to claim 1, wherein the fence nonwoven fabric has an air permeability of no more than 277 ft³/min/ft² as measured by ASTM D737.

9. The oil containment/separation fence according to claim 1, wherein the fence nonwoven fabric has a burst strength of at least 50 pounds per square inch (psi) as measured by ASTM D3786.

10. The oil containment/separation fence according to claim 1, wherein the fence nonwoven fabric has a mean pore size of no more than 34.1 microns.

11. The oil containment/separation fence according to claim 1, wherein the fence nonwoven fabric has retention of at least 87% of its machine direction grab strength as measured using ASTM D5034 when exposed to a xenon light source for 1000 hours.

12. The oil containment/separation fence according to claim 1, wherein the fence nonwoven fabric comprises at least one of nylon, polyester, and polypropylene.

13. The oil containment/separation fence according to claim 2, wherein the fence nonwoven fabric is supported by the plurality of support elements such that, when in use in a body of water and the support elements are in the ground, a top portion of the nonwoven fabric is at least six inches above the body of water.

14. The oil containment/separation fence according to claim 1, wherein the fasteners comprise the straps integrally formed with the fence nonwoven fabric, and wherein the straps are sewn, laminated with an adhesive, glued, melted by a calendering process, or ultrasonically welded to the fence nonwoven fabric.

15. The oil containment/separation fence according to claim 14, wherein the straps and the fence nonwoven fabric comprise the same polymer.

16. The oil containment/separation fence according to claim 1, wherein the fasteners comprise the grommets within the fence nonwoven fabric.

17. The oil containment/separation fence according to claim 1, wherein the fence nonwoven fabric passes the criteria for United States Environmental Protection Agency (EPA) SW-846, Third Edition,
wherein the fence nonwoven fabric has a basis weight of at least 1.5 ounces per square yard (osy) as measured using ASTM D3776,
wherein the fence nonwoven fabric has a machine direction grab elongation of about 84% as measured using ASTM D5034,
wherein the fence nonwoven fabric has a cross direction grab elongation of about 94% as measured using ASTM D5034,
wherein the fence nonwoven fabric has an air permeability of no more than 277 ft³/min/ft² as measured by ASTM D737,
wherein the fence nonwoven fabric has a burst strength of at least 50 pounds per square inch (psi) as measured by ASTM D3786, and
wherein the fence nonwoven fabric has a mean pore size of no more than 34.1 microns.

18. The oil containment/separation fence according to claim 1, wherein the fence nonwoven fabric has a basis weight of 4 about osy as measured by as measured by American Society for Testing and Materials test method (ASTM) D3776,
wherein the fence nonwoven fabric has a thickness of about 22.3 mils as measured using ASTM D1777,
wherein the fence nonwoven fabric has a machine direction grab tensile strength of at least 58 lbs_{f} as measured using ASTM D5034,
wherein the fence nonwoven fabric has a machine direction grab elongation of about 91% as measured using ASTM D5034,
wherein the fence nonwoven fabric has a cross direction grab tensile strength of at least about 38 lbs_{f} as measured using ASTM D5034,
wherein the fence nonwoven fabric has a cross direction grab elongation of about 100% as measured using ASTM D5034,
wherein the fence nonwoven fabric has a machine direction trapezoidal tear strength of at least 14 lbs_{f} as measured by ASTM D5587,
wherein the fence nonwoven fabric has a cross direction trapezoidal tear strength of at least 10 lbs_{f} as measured by ASTM D5587,
wherein the fence nonwoven fabric has an air permeability of about 125 ft³/min/ft² as measured by ASTM D737,
wherein the fence nonwoven fabric has a burst strength of at least 109.4 psi as measured by ASTM D3786,
wherein the fence nonwoven fabric has a mean pore size of about 31 microns, and
wherein the fence nonwoven fabric has a retention of at least 87% of its machine direction grab strength as measured using ASTM D5034 when exposed to a xenon light source for 1000 hours.

19. A method of fabricating an oil containment/separation fence, the method comprising:
fabricating a fence nonwoven fabric; and
fabricating straps attached to the fence nonwoven fabric and configured to be fastened to a plurality of support elements for supporting the nonwoven fabric,
wherein fabricating the fence nonwoven fabric comprises:
feeding and spinning, in an extruder, one or more polymer resins;
extruding the one or more polymer resins in the form of a plurality of filaments;
depositing the filaments onto a collection surface to form a web; and
thermally bonding the filaments of the web to form the fence nonwoven fabric, and
wherein the fence nonwoven fabric has a machine direction grab tensile strength of at least 58 lbs_{f} as measured using American Society for Testing and Materials test method (ASTM) D5034, a cross direction grab tensile strength of at least 38 lbs_{f} as measured using ASTM D5034, a machine direction trapezoidal tear strength of at least 14 lbs_{f} as measured by ASTM D5587, and a cross direction trapezoidal tear strength of at least 10 lbs_{f} as measured by ASTM D5587.

20. A method of fabricating an oil containment/separation fence, the method comprising:
fabricating a fence nonwoven fabric;
inserting a plurality of support elements into the ground within a body of water, near a body of water, or both; and
attaching the fence nonwoven fabric to the plurality of support elements, such that the plurality of support elements support the fence nonwoven fabric,
wherein fabricating the fence nonwoven fabric comprises:
feeding and spinning, in an extruder, one or more polymer resins;
extruding the one or more polymer resins in the form of a plurality of filaments;
depositing the filaments onto a collection surface to form a web; and
thermally bonding the filaments of the web to form the fence nonwoven fabric,
wherein each support element is a stake or a post,
wherein the fence nonwoven fabric is attached to the plurality of support elements using fasteners, wherein the fasteners comprise at least one of the following types of fastener: straps integrally formed with the fence nonwoven fabric; and grommets within the fence nonwoven fabric.
